(19) United States
(12) Patent Application Publication
(10) Pub. No.: US 2025/0128858 A1
(43) Pub. Date: Apr. 24, 2025

(54) CONTAINER LINER

(71) Applicant: Jade Tipton, Spring, TX (US)

(72) Inventor: Jade Tipton, Spring, TX (US)

(21) Appl. No.: 18/381,931

(22) Filed: Oct. 19, 2023

(51) Int. Cl. B65D 25/14; B65D 81/34

(52) U.S. Cl. CPC B65D 25/14; B65D 81/343

(57) ABSTRACT

A container liner to be disposed within a container, the container liner including at least one pad, including a pad body to receive at least one food item thereon, at least one protruding edge disposed on at least a portion of a first edge of the pad body, at least one protrusion receiving edge disposed on at least a portion of a second edge of the pad body, and a plurality of liquid apertures disposed on at least a portion of the pad body to facilitate movement of at least one liquid therethrough, a divider detachably connected to the at least one protrusion receiving edge to prevent mixing of at least one first food item with at least one second food item, and a plurality of pegs disposed on at least a portion of the pad body to elevate the pad body above an interior surface within the container.

### BACKGROUND

### 1. Field

The present general inventive concept relates generally to a liner, and particularly, to a container liner.

### 2. Description of the Related Art

After eating food, some people will store it in a food container, such as an air-sealable container, a bag, a box, and/or any other type of container. Unfortunately, the food container does not prevent the food from becoming soft and wet (i.e., soggy). In particular, the food container is generally placed in a refrigerator, which typically causes condensation to form in the food container and result in soggy food.

The soggy food tends to lose the taste and texture of the food prior to storage and can dampen enjoyment of the food when it is eventually eaten.

Therefore, there is a need for a container liner that prevents the food in the food container from becoming soft and/or wet.

### SUMMARY

The present general inventive concept provides a container liner.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a container liner to be disposed within a container, the container liner including at least one pad, including a pad body to receive at least one food item thereon, at least one protruding edge disposed on at least a portion of a first edge of the pad body, at least one protrusion receiving edge disposed on at least a portion of a second edge of the pad body, and a plurality of liquid apertures disposed on at least a portion of the pad body to facilitate movement of at least one liquid therethrough, a divider detachably connected to the at least one protrusion receiving edge to prevent mixing of at least one first food item with at least one second food item, and a plurality of pegs disposed on at least a portion of the pad body to elevate the pad body above an interior surface within the container.

The pad body may at least partially expand in response to an application of force thereto.

The at least one protruding edge may have a size that is narrower with respect to a remainder of the pad body.

The at least one protrusion receiving edge may detachably connect to at least one protruding edge of at least one other pad.

The pad body may be constructed of a slippery liquid-infused porous surface to prevent the at least one liquid from remaining thereon.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top perspective view of a container liner, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURES, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Container Liner 100
Pad 110
Pad Body 111
Protruding Edge 112
Protrusion Receiving Edge 113
Liquid Apertures 114
Divider 120
Divider Body 121
Connecting Edges 122
Pegs 130

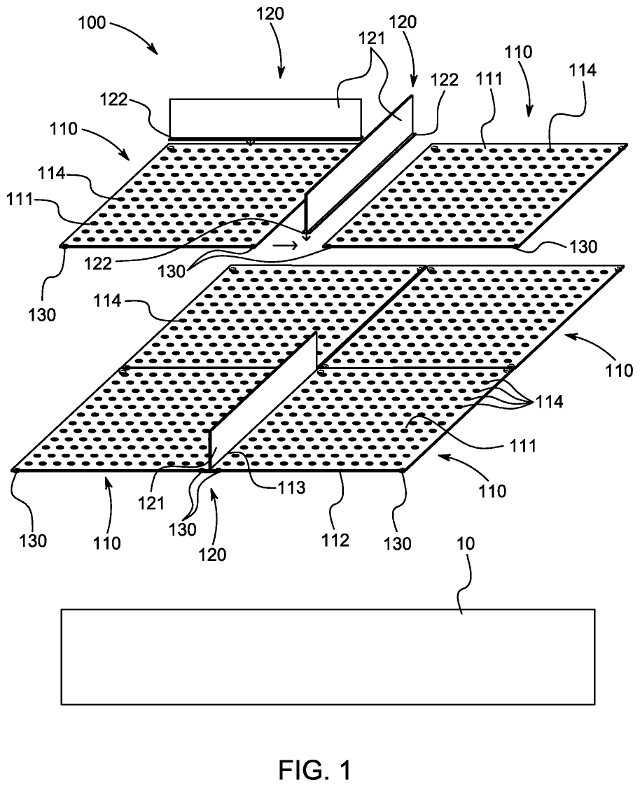

FIG. 1 illustrates a top perspective view of a container liner 100, according to an exemplary embodiment of the present general inventive concept.

The container liner 100 may be constructed from at least one of silicone, metal, plastic, wood, ceramic, glass, and/or rubber, etc., but is not limited thereto. Also, the container liner 100 is heatproof may be inserted into an oven for an oven dish to prevent juice of food from ruining the food.

The container liner 100 may include at least one pad 110, at least one divider 120, and a plurality of pegs 130, but is not limited thereto.

The at least one pad 110 may include a pad body 111, at least one protruding edge 112, at least one protrusion receiving edge 113, and a plurality of liquid apertures 114, but is not limited thereto.

Referring to FIG. 1, the pad body 111 is illustrated to have a rectangular prism shape. However, the pad body 111 may be rectangular, circular, ovular, cylindrical, triangular, pentagonal, hexagonal, heptagonal, octagonal, or any other shape known to one of ordinary skill in the art, but is not limited thereto.

The pad body 111 may be elastic. In other words, the pad body 111 may at least partially deform (i.e., bend, stretch, expand, collapse) in response to an application of force (e.g., pushing, pulling) thereto. As such, the pad body 111 may expand and/or enlarge to fit a predetermined size (e.g., length, width, diameter) and/or a predetermined shape of a container 10. Thus, the pad body 111 may be adjustable to accommodate different types of the container 10 (e.g., air-sealable container, bag, box).

The pad body 111 may be removably disposed within the container 10. The pad body 111 may be constructed to fit a particular type of the container and/or be a one-size-fits all. The pad body 111 may be constructed as a slippery liquid-infused porous surface. The pad body 111 may prevent at least one liquid (e.g., water, juice, sauce, etc.) from remaining thereon. Additionally, the pad body 111 may receive at least one food item thereon, such as during storage in the container 10.

The at least one protruding edge 112 may be disposed on at least a portion of a first edge of the pad body 111. Alternatively, the pad body 111 may have a plurality of protruding edges 112, such as on two edges, three edges, and/or four edges of the pad body 111. The at least one protruding edge 112 may have a size (e.g., length, width) and/or a shape different from a dimension (e.g., a length, width) of a remainder of the pad body 111. For example, the at least one protruding edge 112 may be narrower with respect to the remainder of the pad body 111.

The at least one protrusion receiving edge 113 may be disposed on at least a portion of a second edge of the pad body 111. Alternatively, the pad body 111 may have a plurality of protrusion receiving edges 113, such as on two edges, three edges, and/or four edges of the pad body 111.

The at least one protrusion receiving edge 113 may detachably connect to the at least one protruding edge 112. In other words, the at least one protrusion receiving edge 113 may receive the at least one protruding edge 112 therein. As such, the at least one protruding edge 112 may interlock with the at least one protrusion receiving edge 113.

It is important to note that the at least one protrusion receiving edge 113 of at least one first pad 110 may receive the at least one protruding edge 112 from at least one second pad 110. As such, the at least one first pad 110 and/or the at least one second pad 110 (collectively, two or more pads 110) may detachably connect as described above.

The plurality of liquid apertures 114 may be disposed on at least a portion of a center portion of the pad body 111. The plurality of liquid apertures 114 may facilitate movement of the at least one liquid therethrough. Therefore, the plurality of liquid apertures 114 may prevent accumulation of the at least one liquid on the pad body 111. Also, the pad body 111 may remain dry and/or keep the at least one food item from becoming wet and soft during storage in the container 10.

The at least one divider 120 may include a divider body 121 and a plurality of connecting edges 122, but is not limited thereto.

The divider body 121 may be elongate. Moreover, the divider body 121 may separate the at least one first pad 110 from the at least one second pad 110. For example, the divider body 121 may prevent the at least one food item on the at least one first pad 110 from mixing with the at least one food item on the at least one second pad 110.

Each of the plurality of connecting edges 122 may be disposed on at least a portion of a first side of the divider body 121 and/or at least a portion of a second side of the divider body 121 opposite with respect to the first side of the divider body 121. Each of the plurality of connecting edges 122 may detachably connect to the at least one protrusion receiving edge 113. Referring again to FIG. 1, the plurality of connecting edges 122 may connect the at least one first pad 110 to the at least one second pad 110.

The plurality of pegs 130 may be disposed on at least a portion of the pad body 111. The plurality of pegs 130 may elevate the pad body 111 above an interior surface within the container 10. For example, the plurality of pegs 130 may prevent the pad body 111 from contacting the interior surface of the container 10 and/or prevent the at least one food item from contacting the at least one liquid.

Therefore, the container liner 100 may prevent the at least one food item from becoming soft and/or wet while the at least one food item is stored in the container 10. Also, the container liner 100 may be modified to fit any size and/or shape of the container 10.

The present general inventive concept may include a container liner 100 to be disposed within a container 10, the container liner 100 including at least one pad 110, including a pad body 111 to receive at least one food item thereon, at least one protruding edge 112 disposed on at least a portion of a first edge of the pad body 111, at least one protrusion receiving edge 113 disposed on at least a portion of a second edge of the pad body 111, and a plurality of liquid apertures 114 disposed on at least a portion of the pad body 111 to facilitate movement of at least one liquid therethrough, a divider 120 detachably connected to the at least one protrusion receiving edge 113 to prevent mixing of at least one first food item with at least one second food item, and a plurality of pegs 130 disposed on at least a portion of the pad body 111 to elevate the pad body 111 above an interior surface within the container 10.

The pad body 111 may at least partially expand in response to an application of force thereto.

The at least one protruding edge 112 may have a size that is narrower with respect to a remainder of the pad body 111.

The at least one protrusion receiving edge 113 may detachably connect to at least one protruding edge 112 of at least one other pad 110.

The pad body 111 may be constructed of a slippery liquid-infused porous surface to prevent the at least one liquid from remaining thereon.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A container liner to be disposed within a container, the container liner comprising:
at least one pad, comprising:
a pad body to receive at least one food item thereon,
at least one protruding edge disposed on at least a portion of a first edge of the pad body,
at least one protrusion receiving edge disposed on at least a portion of a second edge of the pad body, and
a plurality of liquid apertures disposed on at least a portion of the pad body to facilitate movement of at least one liquid therethrough;
a divider detachably connected to the at least one protrusion receiving edge to prevent mixing of at least one first food item with at least one second food item; and
a plurality of pegs disposed on at least a portion of the pad body to elevate the pad body above an interior surface within the container.

2. The container liner of claim 1, wherein the pad body at least partially expands in response to an application of force thereto.

3. The container liner of claim 1, wherein the at least one protruding edge has a size that is narrower with respect to a remainder of the pad body.

4. The container liner of claim 1, wherein the at least one protrusion receiving edge detachably connects to at least one protruding edge of at least one other pad.

5. The container liner of claim 1, wherein the pad body is constructed of a slippery liquid-infused porous surface to prevent the at least one liquid from remaining thereon.
